(19) United States
(12) Patent Application Publication
(10) Pub. No.: US 2021/0261266 A1
(43) Pub. Date: Aug. 26, 2021

(54) Aircraft Structure Having An Inlet Opening For Engine Air

(71) Applicant: Airbus Defence and Space GmbH, Taufkirchen (DE)

(72) Inventors: Robert Ehrmayr, Taufkirchen (DE); Thomas Berens, Taufkirchen (DE)

(73) Assignee: Airbus Defence and Space GmbH, Taufkirchen (DE)

(21) Appl. No.: 17/177,390

(22) Filed: Feb. 17, 2021

(30) Foreign Application Priority Data
Feb. 26, 2020 (DE) 10 2020 004 273.2

(51) Int. Cl. B64D 33/02

(52) U.S. Cl. CPC B64D 33/02; B64D 2033/0273; B64D 2033/026

(57) ABSTRACT

An aircraft structure has a fuselage, a wing and an air inlet for receiving air for an engine. The air inlet contains an elevation which rises from the fuselage and the wing. The elevation is arranged in a transition region between the wing and the fuselage and extends asymmetrically with respect to an angle bisector of an angle between a surface of the wing and the lateral surface of the fuselage. By virtue of this construction, a leading edge of the wing can be arranged further forward than the air inlet, and the air inlet configured according to these principles can positively influence a flow boundary layer on the aircraft structure.

### FIELD OF THE INVENTION

The description relates to an aircraft structure, in particular for a supersonic aircraft, and particularly concerns the configuration of an air inlet for receiving air for an engine.

### BACKGROUND OF THE INVENTION

Jet engines are supplied with air and a fuel in order to generate drive energy for an aircraft therefrom. The air is received from the surroundings of the aircraft and is fed to the jet engine via an inlet opening.

For high performance levels or a high drive power of the jet engine, it is advantageous if the inlet flow, that is to say the air received into the inlet opening, has a high degree of energy. In order to achieve this, elevations (so-called bumps) can be arranged on the outer surface of the aircraft and are placed with respect to the inlet openings in such a way that the boundary layer of the flow, which is generated on the outer skin of the aircraft, is deflected away from the inlet opening. The flow boundary layer typically has a lower energy than the air flow spaced apart from the aircraft. By thus deflecting the boundary layer fluid away from the inlet opening, an air flow of higher energy is received into the inlet opening in order to be fed to the jet engine.

U.S. Pat. No. 5,779,189 describes a jet aircraft having an inlet opening for engine air. The inlet opening is either arranged laterally on the fuselage of the jet aircraft and in front of the wing or on an underside of the wing and at a distance from the fuselage of the jet aircraft. On or shortly in front of the inlet opening there is arranged an elevation, a so-called bump, which deflects away from the inlet opening the boundary layer fluid of the air layer bearing on the jet aircraft.

### BRIEF SUMMARY OF THE INVENTION

An aspect of the description relates to an aircraft structure which makes it possible to supply an engine with high-energy air and to improve the maneuverability of an aircraft using the aircraft structure.

According to one aspect, an aircraft structure is specified that has a fuselage, a wing and an air inlet for receiving air for an engine. The air inlet has an elevation which rises from a surface of the fuselage and from a surface of the wing. The elevation is arranged in a transition region between the wing and the fuselage. The elevation extends asymmetrically with respect to an angle bisector of an angle between the surface of the wing and the surface of the fuselage.

The aircraft structure is particularly suitable for use on a jet aircraft. The description herein applies generally to an aircraft structure and a jet aircraft having such an aircraft structure or a jet aircraft whose structure is configured according to the principles described herein.

Even though in the present case there is described only the construction of an individual air inlet on one side of the aircraft structure in connection with a wing and the fuselage, it should be understood that a similar air inlet (in particular of mirror-inverted construction) is arranged between the opposite wing and the opposite lateral surface of the fuselage on the other side of the aircraft structure.

For example, the air inlet and the elevation are arranged on an underside of a wing and the adjoining lateral surface of the fuselage, that is to say in a transition region between the wing and fuselage on the underside of the wing or at an angle which is spanned by the underside of the wing and the adjoining lateral surface of the fuselage. The underside of the wing is to be understood as meaning that surface of the wing which points downwards during a typical orientation of the aircraft structure in flight or else in a parked position, with the direction indications “upwards/downwards” in this coordinate system relating to the vector of the Earth's gravitational force. The direction indication “downwards” points in the direction of the Earth's surface, with “upwards” pointing away therefrom.

Alternatively, the air inlet and the elevation can be arranged on an upper side of the wing and the adjoining lateral surface of the fuselage, that is to say in a transition region between the wing and fuselage on the upper side of the wing or at an angle which is spanned by the upper side of the wing and the adjoining lateral surface of the fuselage. The upper side of the wing is to be understood as meaning that surface of the wing which points upwards during a typical orientation of the aircraft structure in flight or else in a parked position, with the coordinate system introduced above applying to the direction indications “upwards/downwards”.

The air inlet is configured to receive air from the surroundings and to feed it to an engine, in particular a jet engine, and, in combination with a fuel or propellant, to generate drive energy for the aircraft. The air is channelled from the air inlet to the engine via suitable mechanisms which are known in principle.

The air inlet refers in the present case to the entirety of the structural and functional elements which, individually and/or in their interaction, ensure that air is received from the surroundings and fed for further use. In particular, the air inlet includes an elevation or a projection which rises with respect to the surface of the fuselage and the underside or upper side of the wing. The function of this elevation (the so-called bump) is to deflect from an opening of the air inlet a boundary layer fluid of a low-energy boundary layer forming on the outer surface of the aircraft structure in flight. The boundary layer contains a low-energy air flow. For a jet engine, it is advantageous to feed air flow of higher energy in order to improve the performance of the jet engine. Because the elevation deflects the air of the boundary layer (the boundary layer fluid) around the opening of the air inlet or deflects it away from the opening of the air inlet, air flow of higher energy can enter the opening.

In general, the elevation is thus a geometric deformation of the surface of the fuselage and of the wing in order to generate a relative elevation which influences the flow of the boundary layer. The elevation can arise as a result of deformation of the surface and be arranged without an additional element on the surface of the fuselage and of the wing. In principle, however, the elevation can also be individually formed independently of the aircraft structure and be mounted and suitably fastened as an additional element on the fuselage and wing.

In connection with supersonic aircraft, the elevation can also have the function of contributing to the slowing down of the air flow for the engine to subsonic speed. Apart from the elevation, there is preferably arranged no further element on the surface of the aircraft structure that is used for guiding or deflecting the boundary layer fluid around the opening of the air inlet.

An angle is spanned between the surface of the wing, in particular the underside or upper side of the wing, and the surface of the fuselage, in particular a lateral surface of the fuselage. This angle is spanned by the lateral direction of extent of the wing (extent in the direction of a transverse axis of the aircraft structure) and the surface of the fuselage at the point at which the wing meets the fuselage (or at a tangent to this point).

The elevation extends asymmetrically with respect to an angle bisector of the angle between the underside or upper side of the wing and the lateral surface of the fuselage. This means for example that the elevation extends to an unequal degree and/or in a different way along the underside or upper side of the wing and the lateral surface of the fuselage.

This asymmetrical shape of the elevation allows a particularly advantageous deflection of the boundary layer fluid around the air inlet and the other aircraft structure in general and ensures a boundary layer of reduced size.

According to one embodiment, the elevation has a multiply curved contour line.

The contour line of the elevation is that contour which can be seen from a viewing direction which corresponds to the incident flow direction of the aircraft structure in flight. The multiply curved contour line has for example a central hump which is surrounded laterally by in each case two relative depressions. This shape can guide the boundary layer fluid via the elevation in a flow direction at a variable angle with respect to the longitudinal direction of the aircraft structure.

According to a further embodiment, the contour line extends asymmetrically with respect to the angle bisector.

This construction of the elevation makes it possible for the boundary layer fluid to be deflected in an advantageous manner along the outer skin of the aircraft. Thus, for example, a larger part of the elevation can extend along the lateral surface of the fuselage than along the underside or upper side of the wing, or vice versa. It is equally possible for the shape of the contour line of the elevation along the underside or upper side of the wing to extend differently than along the lateral surface of the fuselage.

According to a further embodiment, the contour line hugs the surface of the wing with a first radius of curvature and hugs the surface of the fuselage with a second radius of curvature.

In other words, the surface of the elevation approaches the underside or upper side of the wing and the lateral surface of the fuselage. The first radius of curvature does not have to extend directly up to the surface of the wing. Rather, the region of the contour line having the first radius of curvature can be arranged between the angle bisector and the wing. It analogously applies to the second radius of curvature that the region having the second radius of curvature does not have to extend directly up to the lateral surface of the fuselage, but can be arranged generally between the angle bisector of the angle between the wing and fuselage and the lateral surface of the fuselage.

According to a further embodiment, the first radius of curvature is greater than the second radius of curvature.

Generally, the contour line of the elevation approaches the wing in a different way than it approaches the fuselage, as already expressed by the asymmetrical profile of the contour line. By virtue of the different configuration of the first and second radius of curvature, the profile and the dimensions of the boundary layer along the wing and the fuselage can be optimized.

According to a further embodiment, the wing overlaps the elevation in a direction along a longitudinal axis of the aircraft structure.

This means that the elevation and the air inlet overall are arranged at least partially or else completely below the wing and nevertheless adjoin the lateral surface of the fuselage, that is to say that the elevation is arranged at an angle between the underside or upper side of the wing and the adjoining lateral surfaces of the fuselage.

In this configuration, the leading edge of the wing (front edge of the wing) can be arranged further forward along the longitudinal axis than the air inlet, in particular further forward than the elevation (bump) of the air inlet. This configuration variant has the advantage that the manoeuvrability of an aircraft is improved. The further forward the leading edge of the wings adjoins the fuselage, the better can be the manoeuvrability of the aircraft, because this design variant allows more lift in the high angle of attack range.

According to a further embodiment, the air inlet further has a housing (typically referred to as a cowl) which surrounds the elevation, with the result that an opening for receiving air for the engine is formed between the housing and elevation.

According to a further embodiment, the wing overlaps the housing in a direction along a longitudinal axis of the aircraft structure.

That is to say that, in one variant, both the elevation and the housing are situated below the wing, wherein the leading edge of the wing is further forward in the longitudinal direction of the aircraft (in the direction of the tip of the aircraft structure, in the flight direction) than the housing and the elevation.

According to a further embodiment, the opening is enclosed by the housing, the surface of the fuselage, the elevation and the surface of the wing.

The housing can thus enclose a larger region of the surface of the aircraft structure than just the elevation. However, it is also conceivable in principle for the lateral extensions or ends of the contour line of the elevation to transition into the housing.

According to a further embodiment, the housing has a front edge surface, wherein the front edge surface defines a border of the opening, and wherein the front edge surface is rounded.

The front edge surface of the bordering is rounded rearwardly, that is to say along the longitudinal axis of the aircraft structure, in the incident flow direction of the air. The profile and the dimension of the boundary layer can also be positively influenced as a result.

### BRIEF DESCRIPTION OF THE DRAWINGS

Further details are described with reference to the figures. The figures are schematic and not true to scale.

FIG. 1 shows a schematic illustration of an aircraft structure in plan view.

FIG. 2 shows a schematic illustration of an aircraft structure having an air inlet between the wing and fuselage.

FIG. 3 shows a schematic illustration of an aircraft structure having an elevation between the wing and fuselage.

FIG. 4 shows a schematic illustration of an aircraft structure in plan view having an air inlet below the wing.

FIG. 5 shows a schematic illustration of an aircraft structure having an elevation between the wing and fuselage.

### DETAILED DESCRIPTION

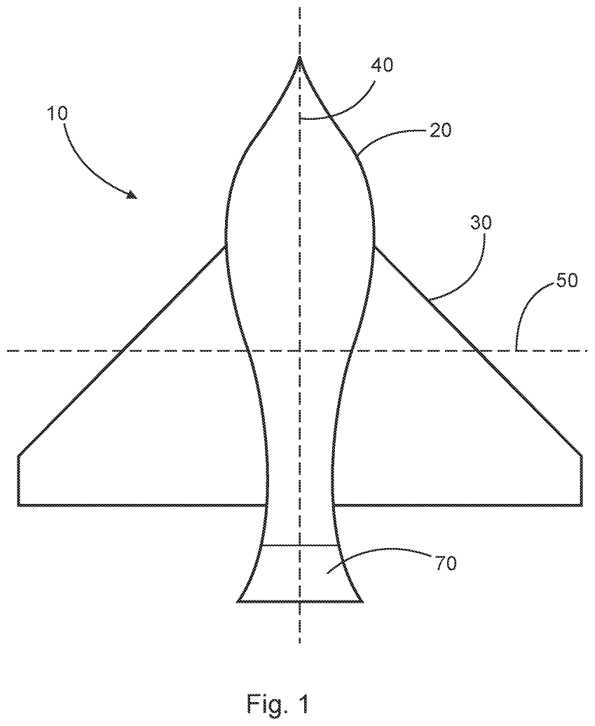

FIG. 1 shows an aircraft structure 10 having a fuselage 20 and two wings 30 which are arranged laterally on opposite sides of the fuselage 20. In the illustration of FIG. 1, the longitudinal axis 40 of the aircraft structure 10 extends from the top (tip of the aircraft structure, at the front in the sense of the flight direction) to the bottom (tail of the aircraft structure, at the rear in the sense of the flight direction). The transverse axis 50 of the aircraft structure extends transversely with respect to the longitudinal axis 40 and from wing to wing.

The aircraft structure 10 has one or more engines 70. The engines can be arranged at various positions on the aircraft structure. The illustration of FIG. 1 is to be seen merely by way of example. The engines 70 are supplied with air from the surroundings of the aircraft structure. The air is used together with a fuel in order to provide drive energy.

The aircraft structure 10 of FIG. 1 can be part of an aircraft, in particular an aircraft having a jet engine, further in particular of a supersonic aircraft.

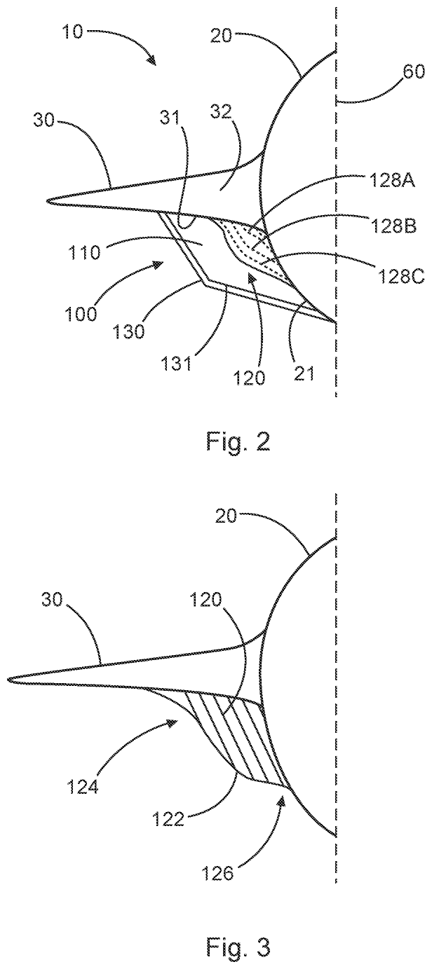

FIG. 2 shows a front view of an aircraft structure 10, that is to say from a viewing direction of the incident flow direction of the air during flight. FIG. 2 shows only one side of the aircraft structure 10. It should be understood that the second side of the aircraft structure 10 is of analogous construction, in particular of mirror-inverted construction to the side shown in FIG. 2.

The wing 30 extends in the direction of the transverse axis 50 (see FIG. 1) from the fuselage 20. At an angle between the surface 31 (in this example: underside) of the wing 30 and a lateral surface 21 of the fuselage 20 there is arranged an air inlet 100 having an elevation 120 and a housing 130 surrounding the elevation 120. Between the elevation 120 and the housing 130 there is formed an opening 110 through which air flows to the engine.

The elevation 120 is arranged in a transition region between the wing 30 and fuselage 20, that is to say that the elevation bears partially against the wing 30 and partially against the fuselage 20.

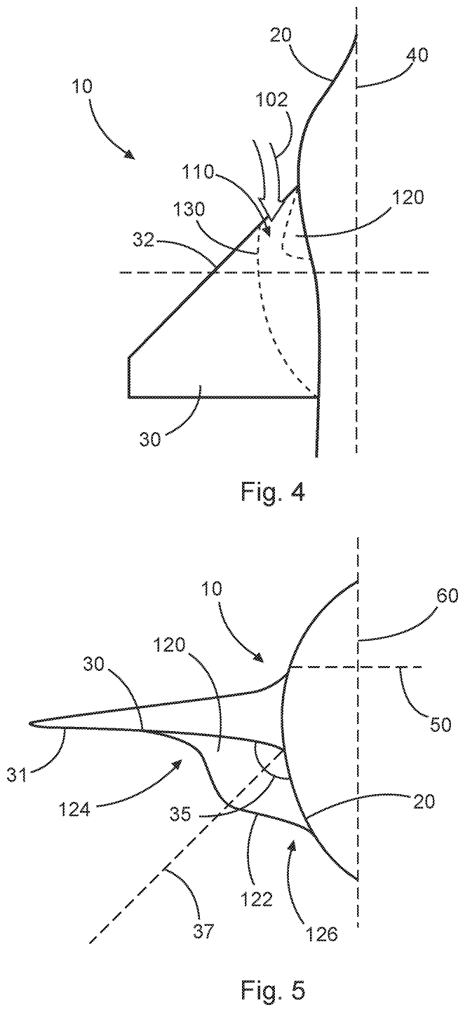

The leading edge 32 of the wing 30 is situated further forward (in the direction out of the drawing plane) in the direction of the longitudinal axis of the aircraft structure than at least one part of the air inlet 100, as can be possibly better recognized in FIG. 4.

The height of the elevation increases from the front to the rear (with respect to the longitudinal axis and in the direction of the incident flow of the aircraft in flight), wherein the height of the elevation is to be understood as meaning the distance of the surface of the elevation from the wing and the fuselage without elevation.

In FIG. 2, three height lines 128A, 128B, 128C of the elevation 120 are depicted as dashed lines by way of example. The height line 128A having the lowest height (that is to say the height line which is nearest the transition between the wing and fuselage) is situated the furthest forward with respect to the longitudinal axis of the aircraft structure. The height of the elevation 120 increases with increasing movement towards the rear along the longitudinal axis, as shown by the following height lines 128B and 128C situated further outward. The height increases further until the outermost contour of the elevation is reached, with the contour of the elevation 120 being illustrated by a solid line.

The housing 130 is shown in FIG. 2 in such a way that the points at which the housing 130 adjoins the wing 30 and the fuselage 20 are spaced apart outwardly or downwardly from the elevation 120. The larger this spacing, the larger also tends to be the opening 110. The spacing between the elevation 120 and housing 130 can vary.

The housing 130 has a front edge surface 131. The front edge surface 131 can be rounded towards the rear, for example in the form of a semicircle or some other regular or irregular shape.

It is pointed out that the air inlet 100 together with the associated components (elevation 120, housing 130, opening 110 formed therebetween) can, as an alternative to the placement between the underside 31 and fuselage 20, also be arranged in a transition region between the upper side (opposite the underside 31) of the wing 30 and the fuselage 20. For this placement of the air inlet 100 between the upper side and fuselage, the same principles apply here as are described in this description with respect to the placement between the underside and fuselage. This particularly applies to the configuration and shape of the elevation 120 and the relative arrangement thereof with respect to the wing, the fuselage and the housing. The mere fact that the figures merely show an air inlet on the underside of the wing does not mean that this description is limited to this variant.

FIG. 3 shows a further illustration of an aircraft structure 10 similar to the aircraft structure from FIG. 2. However, the housing is not illustrated in FIG. 3 for reasons of clarity.

In the front view of FIG. 3, the elevation 120 has a contour line 122 which corresponds to the profile of the surface of the elevation at its highest point or at its region furthest removed from the surface of the wing and the fuselage. At its one end, the contour line 122 hugs the wing 30 and, at the other end, the fuselage 20. The contour line 122 is multiply curved; in FIG. 3, the contour line contains, from left to right (that is to say from the wing to the fuselage), a right-hand curvature, which transitions into a left-hand curvature, which in turn transitions into a right-hand curvature.

The first radius of curvature 124 is arranged on the wing side (nearer the wing than the fuselage). The second radius of curvature 126 is arranged on the fuselage side (nearer the fuselage than the wing). The first radius of curvature 124 is greater than the second radius of curvature 126, that is to say that the curvature of the contour line 122 in the region of the first radius of curvature 124 is less pronounced than in the region of the second radius of curvature 126. This configuration of the contour line deflects the boundary layer fluid in an advantageous manner around the air inlet and keeps the dimensions and the thickness of the boundary layer to advantageous values, in particular if the elevation is arranged in the transition region between the wing and fuselage and the leading edge of the wing is further forward than a part of the air inlet or the entire air inlet.

The statements relating to the shape of the contour line 122 in FIG. 3 of course also apply to the contour line of the elevation from other embodiments. These statements can equally apply to some or all height lines 128A, 128B, 128C of the elevation (see FIG. 2). The basic profile of the height lines of the elevation can correspond to the profile of the contour line, that is to say that the respective shape is the same, with only the dimensions being different.

FIG. 4 is a plan view showing a schematic illustration of an aircraft structure 10 in order to show the arrangement of the elevation 120, of the opening 110 and of the housing 130 with respect to the wing 30 and the leading edge 32 of the wing 30.

The elevation 120 and the housing 130 are shown by dashed lines. Between the elevation 120 and housing 130 is situated the opening 110 in order to receive an air flow 102.

First of all, it can be seen that the elevation 120 and the housing 130 are arranged laterally on the fuselage 20 and extend in the transverse direction, that is to say along the transverse axis, from the fuselage 20. The elevation 120 widens from the front to the rear (in FIG. 4 from top to bottom) along a longitudinal axis of the aircraft structure, that is to say that the height of the elevation increases as already described further above. In other words, the height of the elevation 120 increases the further along the longitudinal axis 40 towards the rear one moves. This applies up to the point of the maximum height. Behind the point of the maximum height, the height of the elevation then decreases again and hugs the fuselage.

As can be gathered from FIG. 4, the elevation 120 is arranged completely below the wing 30, that is to say that the point at which the elevation 120 projects from the fuselage is situated behind the leading edge 32 of the wing. It should be noted that the elevation simultaneously projects from the underside of the wing, because it is arranged in the transition region between the wing and the fuselage; see FIGS. 2 and 3. However, this aspect cannot be seen in the plan view.

For reasons of clarity, all that is shown of the housing 130, by way of a dashed line, is the profile of the housing on the underside of the wing. The foremost point of the housing, that is to say the front edge surface 131 (see FIG. 2), is situated, with respect to the longitudinal axis 40, further to the rear than the foremost point of the elevation 120. The point of the maximum height of the elevation can be situated in front of or behind the front edge surface 131 of the housing 130, that is to say inside or outside the housing 130. This parameter can be varied in dependence on the geometry of the aircraft structure and the desired flow and flight properties.

FIG. 5 shows, as a supplement to the illustration in FIG. 3, the asymmetry of the elevation 120 in a front view of the aircraft structure 10. The elements and properties which have already been described with reference to FIG. 3 will not be described again.

An angle 35 is spanned between the wing 30 and the fuselage 20. This angle is defined by the position and orientation of the underside of the wing and the lateral surface of the fuselage at the point at which the wing and the fuselage adjoin one another or meet one another.

For the angle 35 between the wing 30 and fuselage 20 there is illustrated an angle bisector 37 as a dashed line. With respect to the angle bisector 37, the contour line 122 of the elevation 120 is asymmetrical. This means that the radii of curvature 124, 126 are different or that the elevation is generally arranged asymmetrically at the angle 35 between the wing and fuselage, that is to say is displaced in the direction of the fuselage or in the direction of the wing. Such a displacement can be recognized by the fact that the distance between the lateral surface of the fuselage and an outermost point of the elevation 120 along the transverse axis 50 is greater than or smaller than a distance between the underside of the wing 30 and an outermost point of the elevation 120 along the vertical axis 60.

It is pointed out that “comprising” or “having” does not exclude any other elements or steps nor any higher number of elements and steps than explicitly specified, than specified in the claims and/or the description. “A”, “an” or “one” does not exclude a plurality. Features or steps which have been described with reference to one of the above exemplary embodiments can also be used in combination with other features or steps of other above-described exemplary embodiments. Reference signs in the claims are not to be considered as a limitation.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 Aircraft structure
20 Fuselage
21 Surface
30 Wing
31 Surface
32 Leading edge
35 Angle
37 Angle bisector
40 Longitudinal axis
50 Transverse axis
60 Vertical axis
70 Engine
100 Air inlet
102 Air flow
110 Opening
120 Elevation
122 Contour line
124 First radius of curvature
126 Second radius of curvature
128 Height lines
130 Housing
131 Front edge surface

1. An aircraft structure comprising:
a fuselage;
a wing;
an air inlet for receiving air for an engine;
wherein the air inlet has an elevation which rises from a surface of the fuselage and from a surface of the wing;
wherein the elevation is arranged in a transition region between the wing and the fuselage;
wherein the elevation extends asymmetrically with respect to an angle bisector of an angle between the surface of the wing and the surface of the fuselage.

2. The aircraft structure according to claim 1, wherein the elevation has a multiply curved contour line.

3. The aircraft structure according to claim 2, wherein the contour line extends asymmetrically with respect to the angle bisector.

4. The aircraft structure according to claim 2,
wherein the contour line hugs the surface of the wing with a first radius of curvature;
wherein the contour line hugs the surface of the fuselage with a second radius of curvature.

5. The aircraft structure according to claim 4, wherein the first radius of curvature is greater than the second radius of curvature.

6. The aircraft structure according to claim 1, wherein the wing overlaps the elevation in a direction along a longitudinal axis of the aircraft structure.

7. The aircraft structure according to claim 1, wherein the air inlet further comprises a housing which surrounds the elevation, such that an opening for receiving air for the engine is formed between the housing and elevation.

8. The aircraft structure according to claim 7, wherein the wing overlaps the housing in a direction along a longitudinal axis of the aircraft structure.

9. The aircraft structure according to claim 7, wherein the opening is enclosed by the housing, the surface of the fuselage, the elevation and the surface of the wing.

10. The aircraft structure according to claim 7,
wherein the housing has a front edge surface which defines a border of the opening;
wherein the front edge surface is rounded.
